(19) United States
(12) Patent Application Publication
(10) Pub. No.: US 2022/0063122 A1
(43) Pub. Date: Mar. 3, 2022

(54) ROPE RECOVERY TOOL

(71) Applicant: Mario John CUFONE, Greenwith (AU)

(72) Inventor: Mario John CUFONE, Greenwith (AU)

(21) Appl. No.: 17/444,921

(22) Filed: Aug. 12, 2021

(30) Foreign Application Priority Data
Aug. 26, 2020 (AU) 2020223701

(51) Int. Cl. B26D 7/26; B63B 21/20; B26D 1/06

(52) U.S. Cl. CPC B26D 7/2628; B26D 1/06; B63B 21/20

(57) ABSTRACT

A rope recovery tool for use on an anchor rope including a weight and a saddle that enclose the anchor rope. A blade adapted to be nested between the saddle and the weight there being a recovery rope attached to the rope recovery tool. In use the tool is fed down the anchor rope until it reaches its end and the recovery rope is then used to pull on the tool causing the blade to cut the rope to make it recoverable whilst sacrificing the anchor.

### FIELD OF THE INVENTION

The present invention relates to a rope recovery tool where the rope is attached to an anchor and the anchor cannot be retrieved.

### BACKGROUND TO THE INVENTION

Recreational fishing is a very popular past time. Typical fishing boats are anywhere between 5 to 10 meters in length and once a desired fishing spot is found engage an anchor to keep the boat in the same position which otherwise would drift. The anchor is first connected to a chain that keeps the anchor flat on the sea floor and the chain is then connected to a rope that extends from the boat. The depth that may be fished may be tens or hundreds of metres deep and because typically the rope extends to the boat at an angle the rope in the water maybe a few hundred metres long.

The anchor is subsequently winched up but there are times when the anchor snags on the sea floor. Larger boats that have the engine capacity are generally able to simply forcefully drag the anchor, but smaller vessels may not have the power to do so. At times, the only option for the boat operator is the cut the rope. A buoy may be attached to the end of the rope for subsequent retrieval perhaps by a diver but if it is deep then the cost to retrieve the rope and anchor becomes prohibitive.

Having a length of rope freely moving around the sea floor or even floating is an obvious hazard and undesirable.

The object of this invention is to provide a tool that recovers the rope even if an anchor is shagged and not retrievable.

### SUMMARY OF THE INVENTION

In a first aspect the invention comprises a rope recovery tool for use on an anchor rope including:

a weight and a saddle that enclose the anchor rope;
a blade adapted to be nested between the straddle and the weight;
a recovery rope attached to the rope recovery tool;
whereby in use the tool is fed down the anchor rope until it reaches its end and the recovery rope is then used to pull on the tool causing the blade to cut the rope.

In preference the blade has a scissor mouth, which intersects the anchor rope and then the blade cuts into the anchor rope.

In preference the blade has screw holes, through which a bolt can be screwed into to fix the blade on the straddle of the recovery tool.

In preference the bolt screws in sequence through a screw hole on the straddle, the screw holes of the blade, another screw hole on the straddle and then into a nut to ensure that the blade remains in place.

In preference the saddle is permanently attached to the weight by hinges on one side in the axial direction and is lockably connected to the weight on the other side in the axial direction.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will refer to several drawings as follows.

FIG. 1 is a schematic view of the use of the rope recovery tool according to an embodiment of the present invention;

FIG. 2 is a front view of the rope recovery tool according to an embodiment of the present invention;

FIG. 3 is a back view of the rope recovery tool according to an embodiment of the present invention;

FIG. 4 is a front view of the rope recovery tool in an unlocked state according to an embodiment of the present invention;

FIG. 5 is a right view of the rope recovery tool according to an embodiment of the present invention;

FIG. 6 is a left view of the rope recovery tool according to an embodiment of the present invention;

FIG. 7a is a three-dimensional top view of one side of the blade according to an embodiment of the present invention;

FIG. 7b is a three-dimensional top view of the other side of the blade according to an embodiment of the present invention;

FIG. 8a is a three-dimensional top view of the rope recovery tool with part of the anchor rope according to an embodiment of the present invention; and

FIG. 8b is a three-dimensional perspective top view of the rope recovery tool with part of the anchor rope according to an embodiment of the present invention.

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

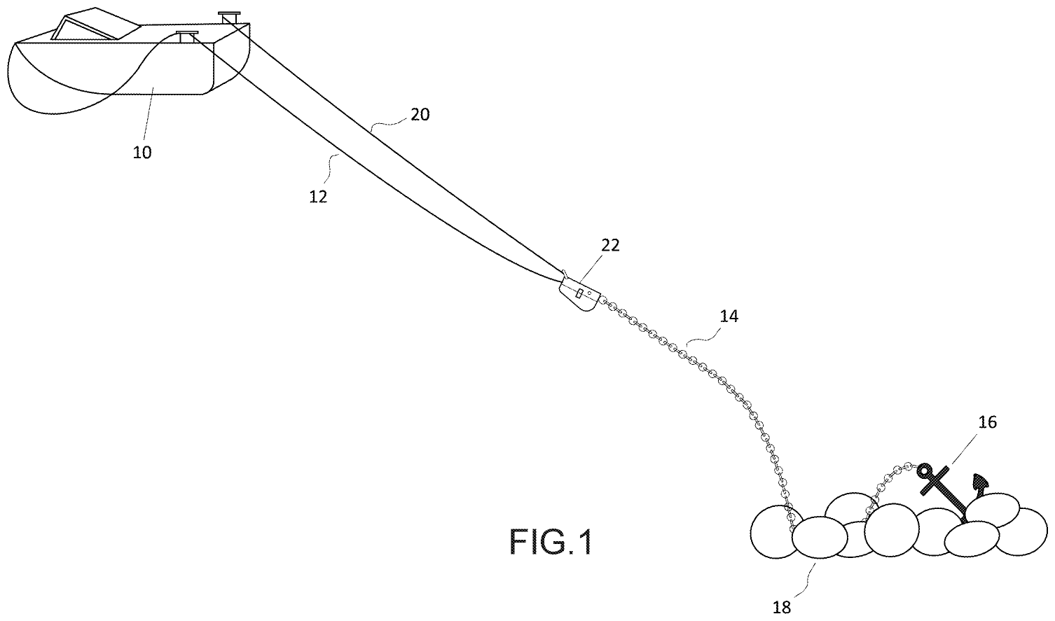

Referring now to the Figures in detail, as shown in FIG. 1, a boat 10 uses an anchor rope 12 attached to an anchor chain 14 that is connected to an anchor 16. When the anchor 16 becomes snagged and cannot be retrieved from the sea floor 18 by moving the boat 10 the recovery tool 22 is used.

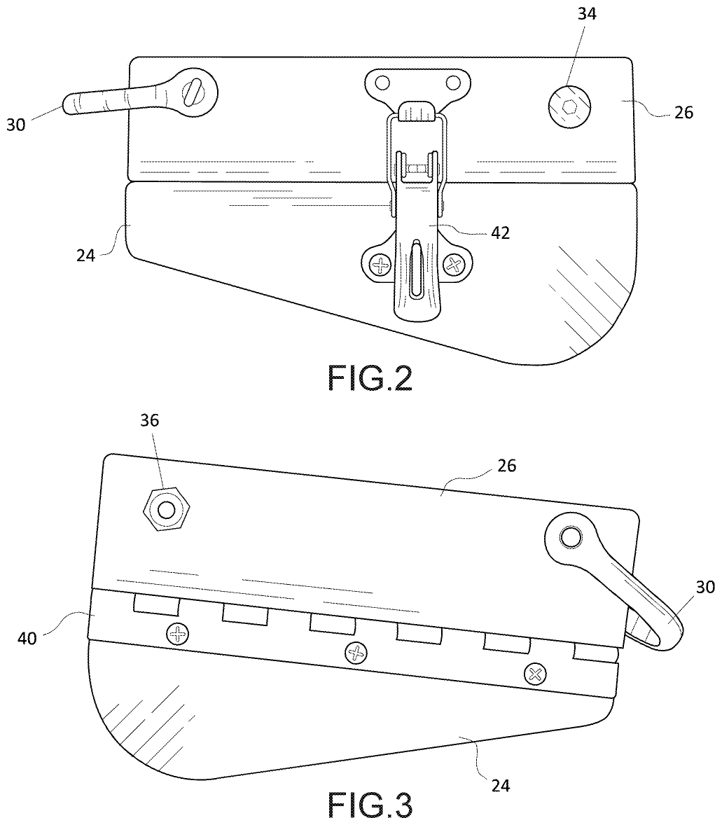

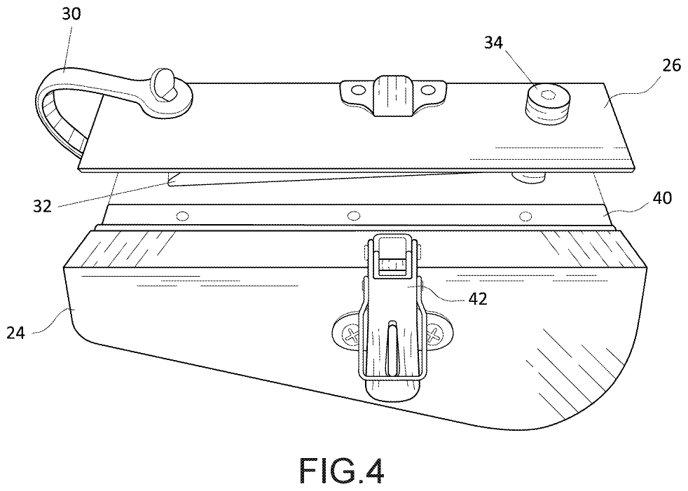

As shown in FIGS. 2-6, a weight 24 and a saddle 26 are connected using a hinge 40 and a hash lock 42 to form a cavity that enclose the anchor rope 12 which needs retrieving. The cavity could be opened or closed by unlocking or locking the hash lock 42. In a preferable embodiment the saddle is permanently attached to the weight by a hinge 40 on one side in the axial direction and is lockably connected to the weight 24 on the other side in the axial direction. When the anchor rope 12 is placed by the operator into the cavity and afterwards the hash lock 42 is locked, then the anchor rope 12 will be captured in the cavity between the straddle 26 and the weight 24. Consequently, the anchor rope 12 can only move forward or backward along its axial direction in the cavity.

The recovery tool 22 is then fed down the anchor rope 12 using a recovery rope 20 that is attached to the recovery tool 22 using a shackle 30 or other types of connecting link devices. The weight 24 ensures that the recovery tool 22 slides downward on the anchor rope 12. The size of the cross section of the cavity formed by the weight 24 and the saddle 26 is bigger than that of the anchor rope 12 but smaller than that of the anchor chain 14. When the recovery tool 22 reaches the end of the anchor rope 12 where the anchor chain 14 starts, it will stop there. Then, the operator can pull the recovery tool 22 by pulling the recovery rope 20 to cut the anchor rope 12 such that it can be retrieved by the operator. In some embodiments of the present invention, the recovery tool 22 can be manufactured in different sizes according to the varying size of the anchor rope 12 without any substantial structural changes to the recovery tool 22 as long as its diameter is small than that of the anchor chain 14.

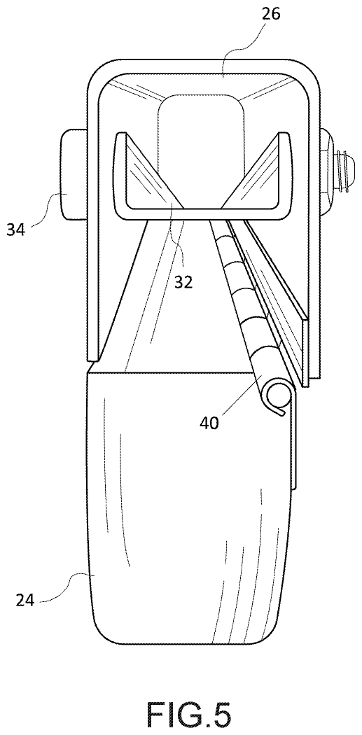

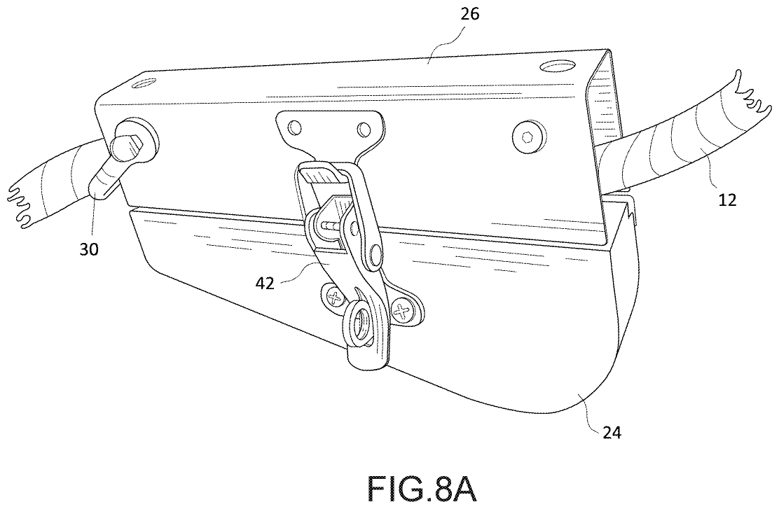

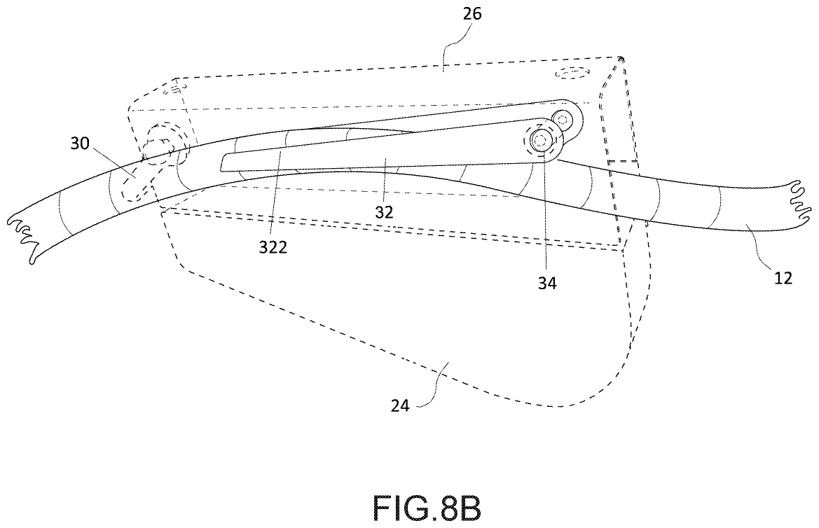

Referring to FIGS. 4-6, in some embodiments, located within the recovery tool 22 is a blade 32 which preferably has a scissor mouth 322 as its cutting surface at one end and screw holes at the other far end of it, through which a bolt 34 can be screwed into in order to fix the blade 32 on the straddle 26 of the recovery tool 22. More specifically, the bolt 34 screws in sequence through one screw hole on the straddle 26, screw holes of the blade 32, the other screw hole on the straddle 26 and finally into a nut 36 to ensure that the blade 32 remains in place as shown in FIG. 4 and FIG. 8b. As a result, the blade 32 can rotate under the effect of gravity around the bolt 34 as its rotating pivot in a small range of degrees when there is nothing in the cavity because its movements are limited in the cavity between the straddle 26 the weight 24. The configuration of the blade 32 is shown in FIGS. 7a and 7b in detail.

FIGS. 8a and 8b show how the rope recovery tool 22 works with part of the anchor rope 12 according to an embodiment of the present invention. When the recovery tool 22 slides down along the anchor rope 12, the cutting surface of the blade 32 which is preferably the scissor mouth 322 is facing away from the anchor rope 12, which therefore is unable to cut the anchor rope 12. Whereas as the recovery tool 22 is being pulled up, the scissor mouth 322 intersects with the anchor rope 12 and then the blade 322 cuts into the anchor rope 12 and eventually cuts through it under the pulling force of the operator and the force of friction, separating the anchor rope 12 from the anchor chain 14 and the anchor 16 and allowing the anchor rope 12 to be retrieved. The recovery tool 22 is then also retrieved using the recovery rope 20.

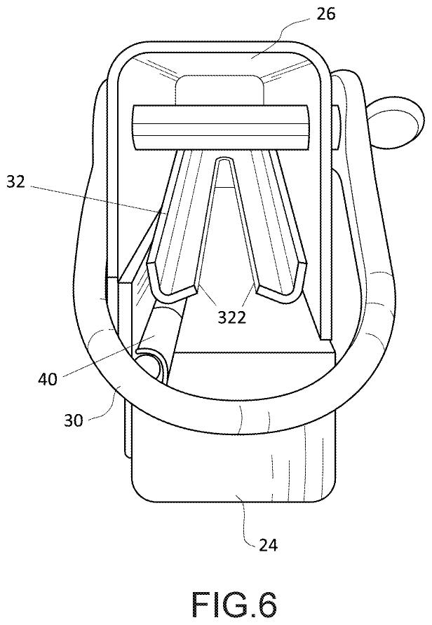

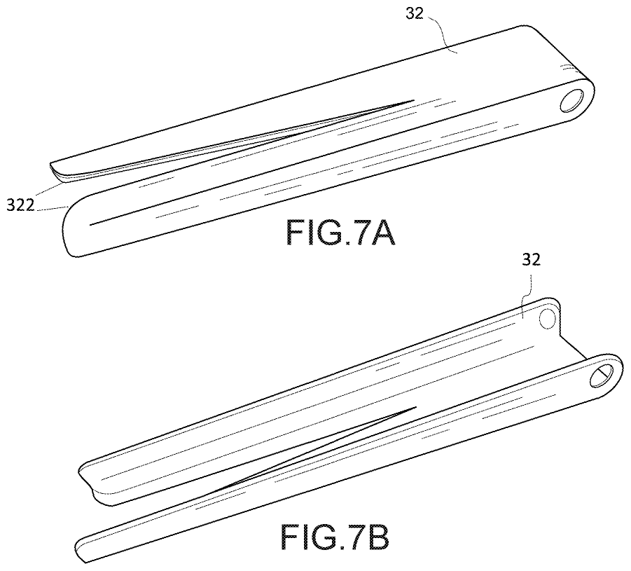

The dimensions of the recovery tool 22 may be selected based upon a range of anchor rope thicknesses but for typical small boats is of the order of some 20 cm long and 10 cm tall. The cross section of the recovery tool 22 can be like a rectangle shape as shown in FIGS. 5-6 or other shapes, such as a square or an ellipse, which does not affect the protection scope of the present invention. The weight 24 may be cut or a cast block.

The recovery tool 22 provided by the present invention is designed skillfully to place the blade 22 between the weight 24 and the saddle 26, make use of the gravity, the pulling force of the operator and the friction force between the blade 22 and the anchor rope 12 that occurs during the course of pulling the anchor rope 12 against the blade 22 in the cavity, to cut the anchor rope 12 through and retrieve the anchor rope 12 that left in the sea water. It provides a practical approach to retrieve the anchor rope 12 with low cost.

The reader will now appreciate the present invention which provides a rope recovery tool where the rope is attached to an anchor and the anchor cannot be retrieved.

### LIST OF COMPONENTS

The drawings include the following integers.
a boat 10
an anchor rope 12
an anchor chain 14
an anchor 16
sea floor 18
a recovery rope 20
a recovery tool 22
a weight 24
a saddle 26
a shackle 30
a blade 32
a scissor mouth 322
a bolt 34
a nut 36
a hinge 40
a hash lock 42

Further advantages and improvements may very well be made to the present invention without deviating from its scope. Although the invention has been shown and described in what is conceived to be the most practical and preferred embodiment, it is recognized that departures may be made therefrom within the scope of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A rope recovery tool for use on an anchor rope including:
a weight and a saddle that enclose the anchor rope;
a blade adapted to be nested between the saddle and the weight;
a recovery rope attached to the rope recovery tool;
whereby in use the tool is fed down the anchor rope until it reaches its end and the recovery rope is then used to pull on the tool causing the blade to cut the rope.

2. The rope recovery tool of claim 1, wherein the blade has a scissor mouth, which intersects the anchor rope and then the blade cuts into the anchor rope.

3. The rope recovery tool of claim 1, wherein the blade has screw holes, through which a bolt can be screwed into to fix the blade on the saddle of the recovery tool.

4. The rope recovery tool of claim 3, wherein the bolt screws in sequence through a screw hole on the saddle, the screw holes of the blade, another screw hole on the saddle and then into a nut to ensure that the blade remains in place.

5. The rope recovery tool of claim 1, wherein the saddle is permanently attached to the weight by hinges on one side in the axial direction and is lockably connected to the weight on the other side in the axial direction.
